(19) United States
(12) Patent Application Publication
(10) Pub. No.: US 2025/0274781 A1
(43) Pub. Date: Aug. 28, 2025

(54) DYNAMIC HARDWARE RESOURCE ALLOCATION FOR TELECOMMUNICATIONS NETWORKS

(71) Applicant: T-Mobile USA, Inc., Bellevue, WA (US)

(72) Inventors: Deveshkumar Narendrapratap Rai, Overland Park, KS (US); Satish Gobarbhai Thumar, Overland Park, KS (US)

(21) Appl. No.: 18/589,115

(22) Filed: Feb. 27, 2024

(51) Int. Cl. H04W 24/02; H04L 41/16

(52) U.S. Cl. CPC H04W 24/02; H04L 41/16

(57) ABSTRACT

Systems and methods for dynamic hardware allocation for telecommunications networks. The system accesses one or more records indicative of network demand at a radio access network (RAN) node, wherein the RAN node is capable of supporting at least two network standards and comprises one or more hardware components for cell site infrastructure shared between the at least two network standards. The system may then extract, from the records, metrics indicative of network demand for each network standard and input the metrics into a machine learning model to determine a distance and directionality of each device from the node. Based on the distance, the system identifies an allocation of hardware for each of the at least two standards and generates one or more commands for enabling real-time modification of at least one hardware component to implement the allocation.

### BACKGROUND

A telecommunications network is established via a complex arrangement and configuration of many cell sites that are deployed across a geographical area. For example, there can be different types of cell sites (e.g., macro cells, microcells, and so on) positioned in a specific geographical location, such as a city, neighborhood, and so on). These cell sites strive to provide adequate, reliable coverage for mobile devices (e.g., smart phones, tablets, and so on) via different frequency bands and radio networks such as a Global System for Mobile (GSM) mobile communications network, a code/time division multiple access (CDMA/TDMA) mobile communications network, a 3rd or 4th generation (3G/4G) mobile communications network (e.g., General Packet Radio Service (GPRS/EGPRS)), Enhanced Data rates for GSM Evolution (EDGE), Universal Mobile Telecommunications System (UMTS), or Long Term Evolution (LTE) network), 5th generation (5G) with New Radio (NR), mobile communications network, 6th generation (6G), Open Radio Access Network (O-RAN), cloud, satellite communication, IEEE 802.11 (WiFi), or other communications networks. The devices can seek access to the telecommunications network for various services provided by the network, such as services that facilitate the transmission of various forms of data over the network and/or provide content to the devices.

Networks like these facilitate interconnectedness between devices so that services and applications that are hosted on servers can share data across devices. In particular, cell towers include hardware components that enable connectivity for devices. Hardware components may include, for example, radio amplifiers, antennas, base transceivers, baseband units, etc. by transmitting information using different protocols (e.g., 4G, 5G, 6G, etc.). In many cases, hardware components are shared amongst different network standards, e.g., 6G, 4G, 5G, etc., using static allocations of each.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3A is a block diagram illustrating a suitable computing environment within which to perform dynamic hardware allocation for telecommunications networks using machine learning techniques, in accordance with one or more implementations.

FIG. 3B is a block diagram illustrating the components of an exemplary system for performing dynamic hardware allocation for telecommunications networks, in accordance with one or more implementations.

FIG. 4 is a block diagram illustrating an exemplary record, in accordance with one or more implementations.

FIG. 5 is a flow diagram illustrating a process for dynamic hardware allocation for telecommunications networks using machine learning techniques, in accordance with one or more implementations.

FIG. 6 is a block diagram that illustrates an example of a computer system in which at least some operations described herein can be implemented.

The technologies described herein will become more apparent to those skilled in the art from studying the Detailed Description in conjunction with the drawings. Implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Networks facilitate interconnectedness between devices so that services and applications that are hosted on servers can share data across devices. Devices may connect through cell towers which include specialized hardware components that enable connectivity for devices, such as radio amplifiers, antennas, base transceivers, baseband units, etc. In many cases, different devices may utilize different network standards. For example, a first device may utilize 4G technology while another device may utilize 5G. Because different devices utilize different network standards, cell towers or other radio access network (RAN) nodes often share hardware components amongst the different network standards.

Conventionally, hardware components are configured using static allocations between network standards. For example, for shared radio amplifiers, wattage would be split between different network standards, also referred to herein as network protocols, using a preset ratio determined by an operator. However, such static allocations are not suitable for ever-changing devices within areas, and continually developing technologies make such static allocations of shared hardware components frequently outdated. For example, continually shifting populations and trends in certain types of electronic devices often leads to consistently changing demands for certain network standards over others. This subsequently leads to poor network performance at different devices, or no connectivity in other cases.

Accordingly, a mechanism is desired that would enable RAN nodes and network service providers (e.g., operators of the service providers) to be able to dynamically configure allocations for hardware components to reflect changing demands for network standards in an area effectively. One mechanism for doing so uses machine learning techniques to determine distances of singular devices or clusters of devices from a cell tower and identify an allocation of shared hardware components and/or other parameters such as system capacity, electrical power, etc. at the RAN node that intelligently balances network resources across the devices that are currently using, or are likely to use, these resources. Using the identified allocation, a system can generate one or more commands enabled to effectuate configuration of the hardware components according to the identified allocation.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

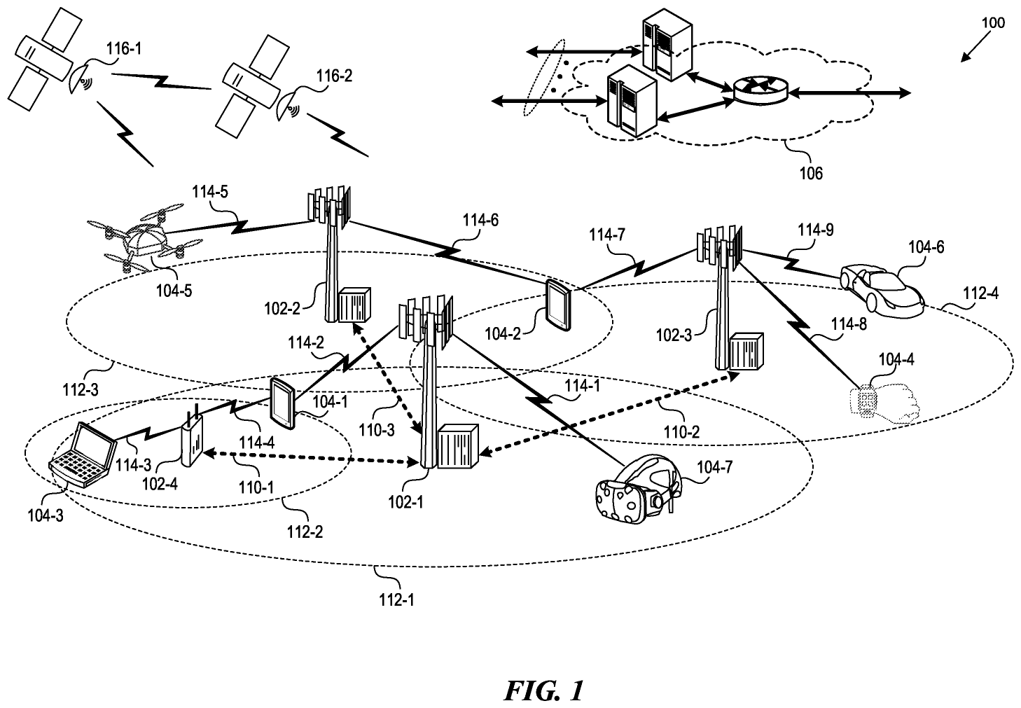

FIG. 1 is a block diagram that illustrates a wireless telecommunications network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104-1 through 104-7 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The geographic coverage area 112 for a base station 102 can be divided into sectors making up only a portion of the coverage area (not shown). The network 100 can include base stations of different types (e.g., macro and/or small cell base stations). In some implementations, there can be overlapping geographic coverage areas 112 for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term eNB is used to describe the base stations 102, and in 5G new radio (NR) networks, the term gNBs is used to describe the base stations 102 that can include mmW communications. The network 100 can thus form a heterogeneous network 100 in which different types of base stations provide coverage for various geographic regions. For example, each base station 102 provides communication coverage for a macro cell, a small cell, and/or other types of cells. As used herein, the term “cell” can relate to a base station, a carrier or component carrier associated with the base station, or a coverage area (e.g., sector) of a carrier or base station, depending on context. In some, the network may use fronthaul links and/or fronthaul connections.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the system 100, where each wireless device 104 can be stationary or mobile. For example, wireless devices include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provides data to a remote server over a network; loT devices such as wirelessly connected smart home appliances, etc.

A wireless device (e.g., wireless devices 104-1, 104-2, 104-3, 104-4, 104-5, 104-6, and 104-7) can be referred to as a user equipment (UE), a customer premise equipment (CPE), a mobile station, a subscriber station, a mobile unit, a subscriber unit, a wireless unit, a remote unit, a handheld mobile device, a remote device, a mobile subscriber station, terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102, and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or Time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites such as satellites 116-1 and 116-2 to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service requirements and multi-terabits per second data transmission in the 6G and beyond era, such as terabit-per-second backhaul systems, ultrahigh-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low User Plane latency. In yet another example of 6G, the network 100 can implement a converged Wi-Fi and Core architecture to increase and improve indoor coverage.

### 5G Core Network Functions

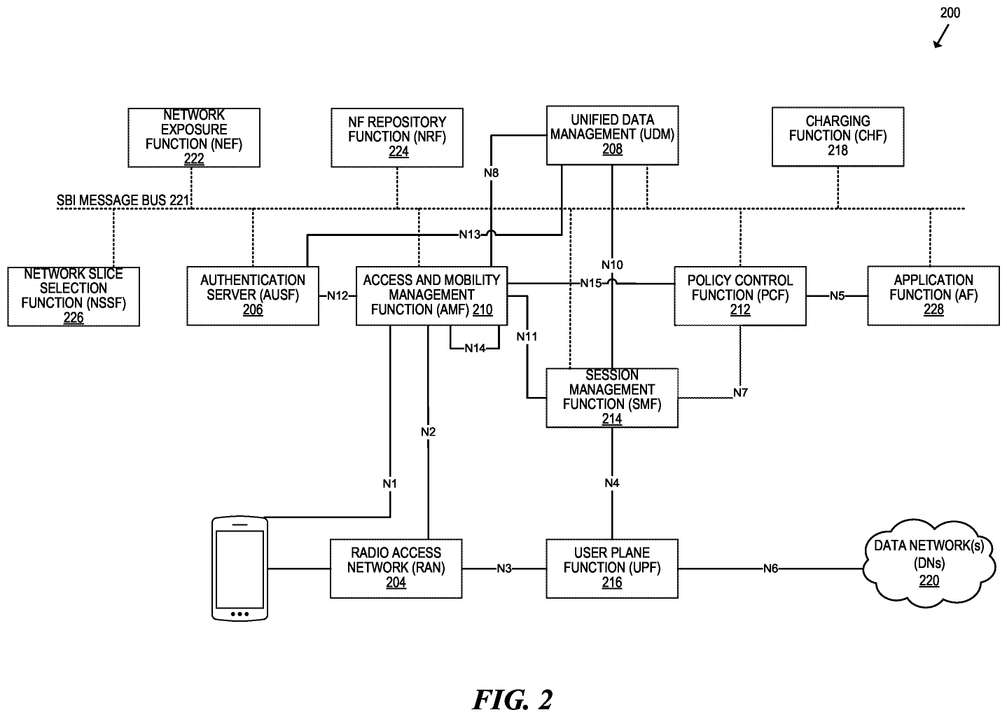

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, a NF Repository Function (NRF) 224 a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, service-level agreements, and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS), to provide authentication credentials while being employed by the AMF 210 and SMF 214 to retrieve subscriber data and context.

The PCF 212 can connect with one or more application functions (AFs) 228. The PCF 212 supports a unified policy framework within the 5G infrastructure for governing network behavior. The PCF 212 accesses the subscription information required to make policy decisions from the UDM 208, and then provides the appropriate policy rules to the control plane functions so that they can enforce them. The SCP (not shown) provides a highly distributed multi-access edge compute cloud environment and a single point of entry for a cluster of network functions, once they have been successfully discovered by the NRF 224. This allows the SCP to become the delegated discovery point in a datacenter, offloading the NRF 224 from distributed service meshes that make-up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224, use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework which, along with the more typical QoS and charging rules, includes Network Slice selection, which is regulated by the NSSF 226.

### Suitable Computing Environments

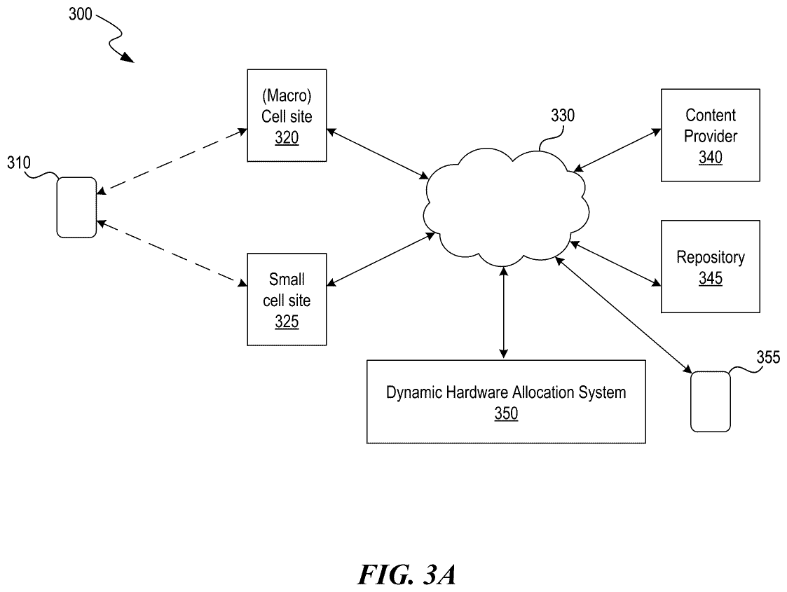

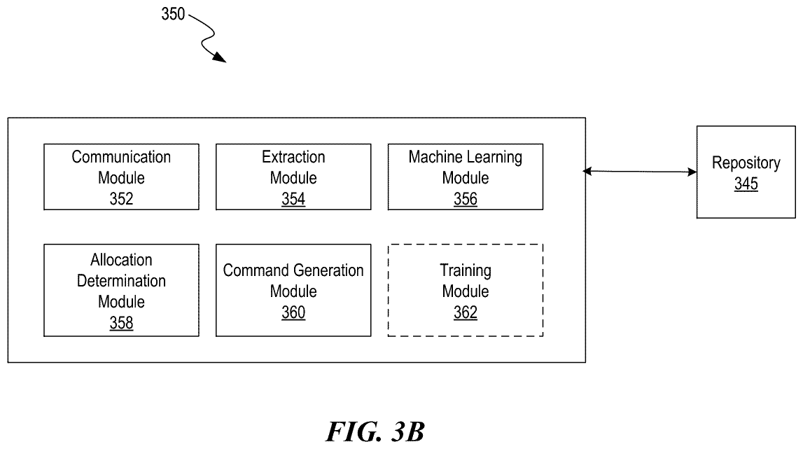

FIG. 3A is a block diagram illustrating a suitable computing environment within which to perform dynamic hardware allocation for telecommunications networks using machine learning techniques, in accordance with one or more implementations. As described herein, the computing environment 300 of FIG. 3A can be used to dynamically configure allocations for hardware components to reflect changing demands for network standards in an area effectively. The system may use a trained machine learning model to determine distances of singular devices or clusters of devices from a cell tower and identify an allocation of shared hardware components. Alternatively or additionally, the machine learning models may determine other parameters to identify the allocation, such as number of devices on each network (e.g., how many devices connected to each of 4G, 5G, 6G, etc.), what the capabilities of each devices are, how many network resources (e.g., baseband capacity) used by each device and/or the like. Using the identified allocation, a system can generate one or more commands enabled to effectuate configuration of the hardware components according to the identified allocation.

Computing environment 300 can include one or more user device(s) 310, one or more cell-sites 320 and 325, telecommunications network 330, content provider 340, cloud data repository 345, one or more other user devices 355, and dynamic hardware allocation system 350. User device(s) 310, such as mobile devices or user equipment (UE) associated with users (such as mobile phones (e.g., smartphones), tablet computers, laptops, and so on), Internet of Things (IOT) devices, vehicles (e.g., smart vehicles), devices with sensors, and so on, can be configured to receive and transmit data, stream content, and/or perform other communications or receive services over a telecommunications network 330, which is accessed by the user device 310 over one or more cell sites 320, 325. For example, the mobile device 310 accesses a telecommunication network 330 via a cell site at a geographical location that includes the cell site, in order to transmit and receive data (e.g., stream or upload multimedia content) from various entities, such as a content provider 340, repository 345, and/or other user devices 355 on the network 330 and via the cell site 320.

The cell sites can include macro cell sites 320, such as base stations, small cell sites 325, such as picocells, microcells, or femtocells, and/or other network access component or sites. The cell cites 320, 325 can store data associated with their operations, including data associated with the number and types of connected users, data associated with the provision and/or utilization of a spectrum, radio band, frequency channel, and capabilities of each device (e.g., what kinds of networks each device can connect to, etc.) and so on, provided by the cell sites 320, 325, and so on. The cell sites 320, 325 can monitor their use, such as the provisioning or utilization of physical resource blocks (PRBs) provided by a cell site physical layer in LTE network; likewise the cell sites can measure channel quality, such as via channel quality indicator (CQI) values, etc.

As described herein, the dynamic hardware allocation system 350 can be used to dynamically allocate hardware components shared between cell sites, such as small cell site 325 and/or macro cell site 320. As referred to herein, cell site may refer to radio access network (RAN) nodes. As referred to herein, hardware components may include any hardware components of a cell site that contribute to providing wireless communication services. For example, a cell site may include components like antennas, radio units, baseband units, power amplifiers, mast or tower structures, cooling systems, power supply and backup systems (e.g., generators and batteries), cabling and fiber optics, and/or the like. The site can include base transceiver stations (BTS), or in the case of 4G networks, may include eNodeBs, which can be used in processing and directing radio signals. In some examples, the hardware components may include remote radio heads (RRHs) that can be located near the antennas and aid in converting digital signals into radio frequencies and vice versa.

Such components may be allocated differently to different network standards, e.g., according to demand or predicted demand. In one example, network standards such as 5G and LTE may be supported at a cell site (e.g., such as small cell site 325 and/or macro cell site 320). The dynamic hardware allocation system 350 may determine, based on one or more records, a demand for network using each type of standard within a given location, such as using one or more machine learning models. For example, the system may determine that there is a large cluster of users using LTE in a first location, and that there is a smaller cluster of users using 5G in a second location. The system may identify allocations for hardware, such as to split the wattage of the shared radio amplifier, or to modify the beamforming to a particular directionality and power. In some cases, the system may consider power and resource usage by users on specific technologies (e.g., on 4G versus 5G, etc.) in determining the allocation. The system may then generate and/or transmit instructions for the same. For example, the instructions may be sent to the hardware components of the cell site to configure them. According to some examples, the instructions may include instructions for multiple cell sites, or clusters of cell sites, e.g., in order to allocate collective resources of the cluster. According to some embodiments, the commands are configured to use software modifications to effectuate real-time modification of behavior of at least one hardware component at the RAN node to implement the identified allocation.

In some examples, the machine learning model is executed on the dynamic hardware allocation system 350, but not trained on the system. For example, in this case, the model can be executed on a remote device and parameters and weights of the trained model can be sent to the system for execution on new samples. In other examples, the machine learning model is trained on the system. The system may receive a dataset comprising metrics indicative of network demand for different combinations of network standards across user devices at one or more cell towers and a corresponding distance of each user device to a corresponding cell tower and train the machine learning model to determine the distance between a user device and a cell tower based on metrics. The machine learning model can be trained, e.g., using data from repository 345 as well.

FIG. 3A and the discussion herein provide a brief, general description of a suitable computing environment 300 in which the dynamic hardware allocation system 350 can be supported and implemented. Although not required, aspects of the dynamic hardware allocation system 350 are described in the general context of computer-executable instructions, such as routines executed by a computer, e.g., mobile device, a server computer, or personal computer. The system can be practiced with other communications, data processing, or computer system configurations, including: Internet appliances, hand-held devices (including tablet computers and/or personal digital assistants (PDAs)), Internet of Things (IoT) devices, all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein, and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system can also be practiced in distributed computing environments where tasks or modules are performed by remote processing devices, which are linked through a communications network, such as a Local Area Network (LAN), Wide Area Network (WAN), or the Internet. In a distributed computing environment, program modules can be located in both local and remote memory storage devices.

Aspects of the system can be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system can be distributed over the Internet or over other networks (including wireless networks), on a propagated signal on a propagation medium (e.g., an electromagnetic wave(s), a sound wave, etc.) over a period of time, or they can be provided on any analog or digital network (packet switched, circuit switched, or other scheme). Portions of the system reside on a server computer, while corresponding portions reside on a client computer such as a mobile or portable device, and thus, while certain hardware platforms are described herein, aspects of the system are equally applicable to nodes on a network. In alternative implementations, the mobile device or portable device can represent the server portion, while the server can represent the client portion.

In some implementations, the user device 310 and/or the cell sites 320, 325 can include network communication components that enable the devices to communicate with remote servers or other portable electronic devices by transmitting and receiving wireless signals using a licensed, semi-licensed, or unlicensed spectrum over communications network, such as telecommunications network 330. In some cases, the telecommunications network 330 can be comprised of multiple networks, even multiple heterogeneous networks, such as one or more border networks, voice networks, broadband networks, service provider networks, Internet Service Provider (ISP) networks, Public Switched Telephone Networks (PSTNs), and/or satellite constellation networks interconnected via gateways operable to facilitate communications between and among the various networks. The telecommunications network 330 can also include third-party communications networks such as a Global System for Mobile (GSM) mobile communications network, a code/time division multiple access (CDMA/TDMA) mobile communications network, a 3rd or 4th generation (3G/4G) mobile communications network (e.g., General Packet Radio Service (GPRS/EGPRS)), Enhanced Data rates for GSM Evolution (EDGE), Universal Mobile Telecommunications System (UMTS), or Long Term Evolution (LTE) network), 5G mobile communications network, IEEE 802.11 (WiFi), 6G, satellite constellation network or other communications networks. Thus, the user device is configured to operate and switch among multiple frequency bands (e.g., for 4G, 5G, and/or the like) for receiving and/or transmitting data.

Further details regarding the operation and implementation of the dynamic hardware allocation system 350 will now be described.

### Examples Of Systems For Dynamic Hardware Allocation

FIG. 3B is a block diagram illustrating the components of an exemplary system for dynamic hardware allocation using machine learning techniques, in accordance with one or more implementations. Dynamic hardware allocation system 350 can include functional modules that are implemented with a combination of software (e.g., executable instructions, or computer code) and hardware (e.g., at least a memory and processor). Accordingly, as used herein, in some examples a module is a processor-implemented module or set of code and represents a computing device having a processor that is at least temporarily configured and/or programmed by executable instructions stored in memory to perform one or more of the specific functions described herein. For example, the dynamic hardware allocation system 350 includes a communication module 352, an extraction module 354, machine learning module 356, allocation determination module 358, and a command generation module 360, each of which is discussed separately below. The dynamic hardware allocation system 350 may optionally include a training module 362 as well.

### Communication Module

Communication module 352 of dynamic hardware allocation system 350 can include software and/or hardware components allowing for the transmission and/or receipt of information between two or more devices. Communication module 352 can include a wireless communication module, such as cellular technology or Wi-Fi technology, to allow for communication over wireless networks, and/or can additionally or alternatively include a network card (e.g., a wireless network card and/or a wired network card) that is associated with software to drive the card.

The communication module 352 is configured and/or programmed (e.g., via the above-mentioned techniques) to interface between a device (e.g., user device(s) 310, one or more other user devices 355), cell sites (e.g., cell sites 320, 325), content provider (e.g., content provider 340), cloud data repository (e.g., cloud data repository 345) such as via a network (e.g., network 330), to receive and transmit data including EDR data, KPI data, device profile data, and/or the like. When communication module 352 receives data, the module can pass on relevant portions of data to different modules of the dynamic hardware allocation system 350. Communication module 352 can also be configured to transmit instructions for reconfiguring a mobile device and/or notifications and/or recommendations to operators.

As described herein, the dynamic hardware allocation system 350 can be used to dynamically allocate hardware components shared between cell sites, such as small cell site 325 and/or macro cell site 320. The dynamic hardware allocation system 350 may determine, based on one or more records, a demand for network using each type of standard within a given location, such as using one or more machine learning models. For example, the system may determine that there is a large cluster of users using LTE in a first location, and that there is a smaller cluster of users using 5G in a second location. The system may identify allocations for hardware, such as to split the wattage of the shared radio amplifier, or to modify the beamforming to a particular directionality and power. The system may then generate and/or transmit instructions for the same. For example, the instructions may be sent to the hardware components of the cell site to configure them.

As such, the communication module 352 may be used to access, for a plurality of user devices within an area, one or more records indicative of network demand at a RAN node (e.g., cell tower), wherein the cell tower is capable of supporting at least two network standards and comprises one or more hardware components for cell site infrastructure shared between the at least two network standards, e.g., from the hardware components themselves, from remote devices (e.g., user device(s) 310), and/or the like. For example, the data received may include, or be used to calculate metrics such as data in a buffer of the cell tower, age of the data in the buffer, traffic load, distance from a tower, and/or concentration of user devices in the area. The communication module 352 can pass the data, or a pointer to the data in memory, to the extraction module 354 for extracting relevant metrics from the received data. In one example, the communication module 352 may receive, e.g., data recently stored in a buffer, and based on the timestamps of when the packet of data first enters the buffer, the extraction module 354 can identify the age of the data in the buffer. The extracted metrics can then be used by the dynamic hardware allocation system 350 to identify allocations of hardware components.

Once the system identifies the hardware allocation, the system can transmit generated commands using the communication module 352. For example, the system may transmit commands within the cell site to the components of the cell site for modification. Alternatively or additionally, the system may transmit one or more commands such as to remote devices, e.g., user device(s) 310 to prompt operators to manually modify the hardware components based on the identified commands. In one example, the system generates a set of commands for modifying and/or configuring each of a set of hardware components based on the determined location/directionality/distance of singular or clusters of user devices.

As described herein, in some implementations, the machine learning model is executed on the dynamic hardware allocation system 350, but not trained on the system. For example, in this case, the model can be executed on a remote device and parameters and weights of the trained model can be received at the communication module 352 of the system for execution on new samples. In some implementations, the machine learning model is trained on the dynamic hardware allocation system 350 via the training module 362. In order to do so, the system first obtains data (e.g., from repository 345) on which to train the model on through the communication module 352. For example, the communication module 352 may access or otherwise obtain a dataset comprising metrics indicative of network demand for different combinations of network standards across user devices at one or more cell towers and a corresponding distance of each user device to a corresponding cell tower and train the machine learning model to determine a distance of a user device from a cell tower based on metrics. The communication module 352 can pass the data, or a pointer to the data in memory, to the training module 362 for training.

### Extraction Module

As described herein, dynamic hardware allocation system 350 obtains, for a plurality of user devices (e.g., user device(s) 310) within an area, one or more records indicative of network demand and/or network performance at a cell tower via communication module 352. The cell tower, as described herein, can be capable of supporting at least two network standards and may include one or more hardware components for cell site infrastructure shared between the at least two network standards. The communication module 352 passes the one or more records to the extraction module 354 to extract metrics indicative of network demand for each network standard across the plurality of user devices in the area from the one or more records.

For example, the metrics may include metrics such as data in a buffer of the cell tower, age of the data in the buffer, traffic load, distance from a tower, and/or concentration of user devices in the area. The data in the buffer and age of the data may be obtained through the communication module 352 from the base station (e.g., eNodeB for LTE and/or gNodeB for 5G). The module may track the data received at the buffer and calculate how long it has been there. Similarly, for traffic load, the base station may measure and monitor the volume of data passing through the cell site, including both uplink and downlink traffic.

For distance from a tower, the extraction module can calculate the distance of the devices from the tower using records from user device(s) 310 that include signal strength and timing advance data and/or round trip time (RTT) measurements between user devices and the cell tower. Similarly, the cell sites can determine the number of active devices under each network standard within their coverage area through communications with these devices. For example, this can be determined using signaling data and the number of active connections.

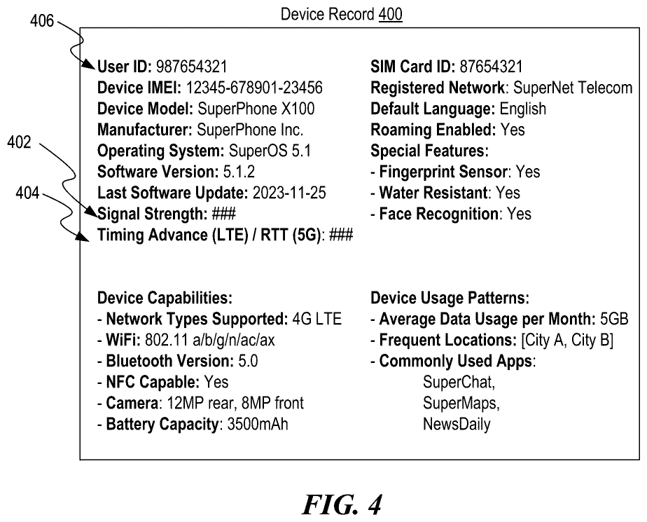

For example, FIG. 4 is a block diagram illustrating an exemplary record for a user device, e.g., device record 400, in accordance with one or more implementations. Device record 400 may be obtained via communication module 352 and passed to the extraction module 354. The extraction module may extract relevant metrics from records including the exemplary device record of FIG. 4. In particular, the extraction module 354 identifies metrics such as a concentration of user devices by determining, e.g., the unique number of device identifiers, e.g., such as “User Device ID” 406. Similarly, the extraction module 354 can identify distance from a tower by extracting relevant metrics from the record such as timing advance value (e.g., “Timing Advance” 404) and signal strength (e.g., “Signal Strength” 402). The system can parse the records between the types of network standards to identify metrics specific to each. In some examples, device record may alternatively or additionally (e.g., in the case of 5G) include a radio access network (RAN) slice identifier to identify different network slices.

The extraction module 354 can pass the data, or a pointer to the data in memory, to the machine learning module 356 to identify locations of user devices and/or network demand.

### Machine Learning Module And Allocation Determination Module

The metrics extracted using the extraction module 354 may be used as inputs into a machine learning model to determine, for each user device of the plurality of user devices, a distance and directionality from the cell tower. For example, the machine learning module 356 may include one or more machine learning models configured to determine distance, location, directionality and/or a combination of such parameters. The machine learning module 356 may be trained on the system or trained on a remote device and transmitted via the network.

The distance, directionality, location and/or network demand outputted by the machine learning module may be used by the allocation determination module 358 to identify locations (e.g., position, pose, etc.) of devices utilizing each network standard. For example, the allocation determination module 358 may identify clusters of user devices at certain locations that utilize each network standard and based on the locations of devices, and/or based on the network demand determined, the allocation determination module 358 may determine an allocation of the shared one or more hardware components that balances the network resources between the user devices that may use the resources. The allocation determination module 358 may pass data indicative of the determined allocation, or a pointer to the data in memory, to the command generation module 360, which may then use the data to generate commands to effectuate a configuration that reflects the determined allocation.

For example, if the output of the machine learning model indicates high traffic load or a large concentration of users in a specific area for particular types of network standards over others, the power output of the radio amplifiers can be increased for the specific network standard to ensure adequate signal strength. The system may also determine to direct signals more precisely by beamforming in a particular configuration if clusters of devices are identified based on the output location (e.g., position, directionality, distance, etc.). Further, if the age of the data is high, the machine learning model may determine that there is network congestion and so there is further need for better data transmission, and the base station may be configured to adjust data transmission policies, adjust antenna tilt and orientation, handover trigger (e.g., conditions that move a device or device data from one cell site to another) and/or the like. For example, a handover trigger may be modified (e.g., increased or decreased) to sustain a threshold level of performance across cell sites. In some examples, the allocation of resources includes modifying a directionality and power of signals to be transmitted by the cell tower.

A “model,” as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data. Examples of models include neural networks, support vector machines, Parzen windows, Bayes, clustering, reinforcement learning, probability distributions, decision trees, decision tree forests, and others. Models can be configured for various situations, data types, sources, and output formats.

In some implementations, the machine learning model used by the system according to implementations herein can be a neural network with multiple input nodes that receive data associated with operation of mobile devices on a network, such as device profiles, EDR data, and/or KPI data. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer, (“the output layer”) one or more nodes can produce a value classifying the input that, once the model is trained, can be used to predict an appropriate modification to a mobile device or a network component. In some implementations, such neural networks, known as deep neural networks, can have multiple layers of intermediate nodes with different configurations, can be a combination of models that receive different parts of the input and/or input from other parts of the deep neural network, or are convolutions-partially using output from previous iterations of applying the model as further input to produce results for the current input.

### Command Generation Module

Command generation module 360 may generate commands based on determined allocations of hardware between allotments for different network standards at a cell site. For example, the module may generate one or more commands for enabling real-time modification of at least one hardware component of the one or more hardware components at the cell tower based on the allocation for each of the at least two network standards. The one or more commands can include a combination of commands for configuring hardware settings and/or software settings of the at least one hardware component.

For example, as described herein, the at least one hardware component can include a radio amplifier having a maximum power output and the determined allocation may include partitioning available wattage of the radio amplifier between a first network standard and a second network standard of the at least two network standards, e.g., based on detection of clusters of user devices using/compatible with the first network standard versus the second network standard.

The command generation module 360 may then pass the one or more commands, or a pointer to the data in memory, to the communication module 352, which can be used to transmit the commands, e.g., to components of the cell site, and/or to remote devices, such as of operators, to notify them to manually configure components of the cell site.

### Training Module

As described herein, the machine learning model may be trained on the dynamic hardware allocation system 350. The training module 362 can be part of the dynamic hardware allocation system 350. In other implementations, the machine learning model may be trained on a different, remote device and the parameters of the machine learning model may be transmitted and stored for execution on the dynamic hardware allocation system 350.

As described herein, in order to train the machine learning model, the training module may first obtain (e.g., from repository 345) data on which to train the model on, such as via communication module 352. For example, the communication module 352 may access or otherwise obtain device records including device profiles, EDR data, KPI data, etc. associated with a plurality of mobile devices as well as data indicative a corresponding distance of each user device to a corresponding cell tower. The system may train the machine learning model to determine the distance of a user device from a cell tower based on metrics.

The training module 362 trains the machine learning model using a set of training data received at or generated by the training module 362. For example, as described herein, the communication module 352 can pass the data, or a pointer to the data in memory, to the training module 362 for training. Training data can include a set of device records such as device profiles, EDR data, and/or KPI data associated with mobile devices that have operated in a network. The training datasets can be labeled according to the distance between devices from the cell site, and/or in some cases a determined network demand. Training data can additionally or alternatively include synthetic data. Based on the training data, the training module 362 can use supervised learning, reinforcement learning, or other learning techniques to train a model that maps device record data to distances that the system may use to identify network demand and/or clusters of devices. For example, a representation of device records, as well as a corresponding distance, can be provided to the model. Output from the model (e.g., a predicted distance) can be compared to the desired output for the mobile device given the inputs. Based on the comparison, the model can be modified, such as by changing weights between nodes of the neural network or parameters of the functions used at each node in the neural network (e.g., applying a loss function). After applying each data item in the training datasets and modifying the model in this manner, the model can be trained to evaluate new device records. Once the model is trained based on the received data, the system may store the parameters of the trained model and execute the model when needed.

### Flow Diagram

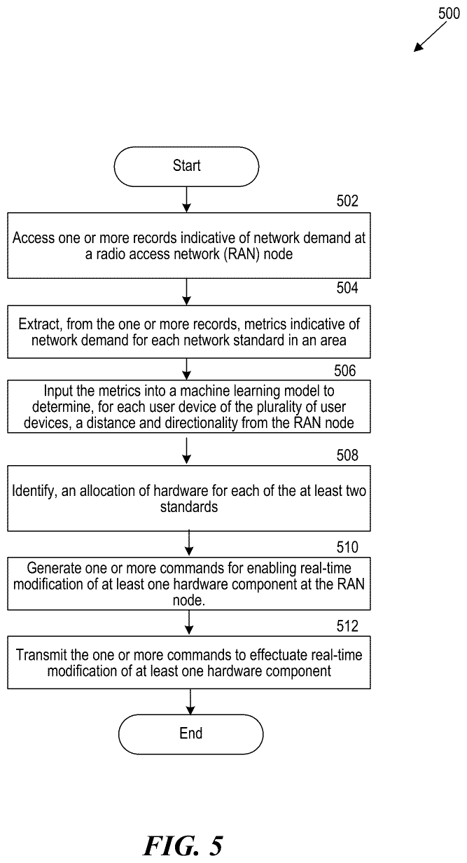

FIG. 5 is a flow diagram illustrating a process for dynamic hardware allocation using machine learning techniques, in accordance with one or more implementations. Process 500 begins at block 502 where a system (e.g., such as dynamic hardware allocation system 350) accesses one or more records indicative of network demand at a radio access network (RAN) node (as discussed above in reference to the communication module 352). At block 504, process 500 includes extracting, from the one or more records, metrics indicative of network demand for each network standard in an area. Process 500 then proceeds to block 506 where a system inputs the metrics into a machine learning model to determine, for each user device of the plurality of user devices, a distance and directionality from the RAN node.

At block 508, process 500 identifies, an allocation of hardware for each of the at least two standards. The process proceeds to block 510, where the system generates one or more commands for enabling real-time modification of at least one hardware component at the RAN node. At block 512, the system transmits the one or more commands to effectuate real-time modification of at least one hardware component.

### Computer System

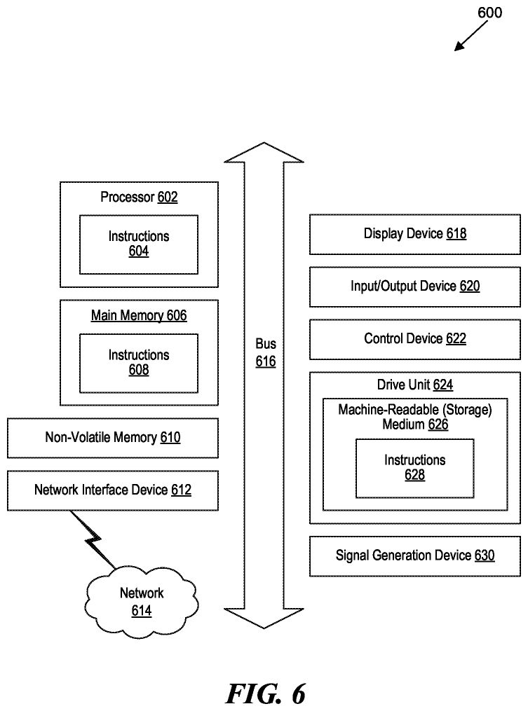

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, video display device 618, an input/output device 620, a control device 622 (e.g., keyboard and pointing device), a drive unit 624 that includes a storage medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 shares a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementation, the computer system 600 can be an embedded computer system, a system-on-chip (SOC), a single-board computer system (SBC) or a distributed system such as a mesh of computer systems or include one or more cloud components in one or more networks. Where appropriate, one or more computer systems 600 can perform operations in real-time, near real-time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable (storage) medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number can also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that can be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

We claim:

1. A method for dynamic hardware allocation for telecommunications networks, comprising:
accessing one or more records indicative of network demand at a radio access network (RAN) node, wherein the RAN node is capable of supporting at least two network standards and comprises one or more hardware components for cell site infrastructure shared between the at least two network standards;
extracting, from the one or more records, metrics indicative of network demand for each network standard across a plurality of user devices in an area serviced by the RAN node;
inputting the metrics into a machine learning model to determine, for each user device of the plurality of user devices, a distance and directionality from the RAN node;
identifying, based on the distance of each user device from the RAN node, an allocation of hardware for each of the at least two network standards;
generating one or more commands for enabling real-time modification of at least one hardware component of the one or more hardware components at the RAN node based on the identified allocation for each of the at least two network standards; and
transmitting the one or more commands, wherein the commands are configured to use software modifications to effectuate real-time modification of behavior of at least one hardware component at the RAN node to implement the identified allocation.

2. The method of claim 1, wherein the metrics comprise data in a buffer of the RAN node, age of the data in the buffer, traffic load, distance from a tower, or concentration of user devices in the area.

3. The method of claim 1, wherein the identified allocation comprises a directionality and power of signals to be transmitted by the RAN node and wherein the one or more commands comprise configuring hardware settings or software settings of the at least one hardware component.

4. The method of claim 1, wherein a first network standard and second network standard of the at least two network standards are different and include any combination of 1G (First Generation), 2G (Second Generation), 3G (Third Generation), 4G (Fourth Generation), 5G (Fifth Generation), or 6G (Sixth Generation).

5. The method of claim 1, wherein the at least one hardware component comprises a radio amplifier having a maximum power output and the identified allocation comprises partitioning available wattage of the radio amplifier between a first network standard and a second network standard of the at least two network standards.

6. The method of claim 1, further comprising:
receiving a dataset comprising metrics indicative of (1) network demand for different combinations of network standards across user devices at one or more RAN nodes and (2) a corresponding distance of each user device to a corresponding RAN node; and
training the machine learning model to determine a distance of a user device from a RAN node based on metrics.

7. The method of claim 1, wherein the one or more commands comprises instructions for beamforming to direct transmission or reception of waves at the RAN node.

8. The method of claim 1, wherein the machine learning model is configured to identify clusters of user devices and the identified allocation comprises a directionality and power proportional to a number of user devices of each cluster.

9. A non-transitory computer-readable medium containing instructions configured to cause one or more processors to perform a method for dynamic hardware allocation for telecommunications networks, the method comprising:
accessing one or more records indicative of network demand at a radio access network (RAN) node, wherein the RAN node is capable of supporting at least two network standards and comprises one or more hardware components for cell site infrastructure shared between the at least two network standards;
extracting, from the one or more records, metrics indicative of network demand for each network standard across a plurality of user devices in an area serviced by the RAN node;
inputting the metrics into a machine learning model to determine, for each user device of the plurality of user devices, a distance and directionality from the RAN node;
identifying, based on the distance of each user device from the RAN node, an allocation of hardware for each of the at least two network standards;
generating one or more commands for enabling real-time modification of at least one hardware component of the one or more hardware components at the RAN node based on the identified allocation for each of the at least two network standards; and
transmitting the one or more commands, wherein the commands are configured to use software modifications to effectuate real-time modification of behavior of at least one hardware component at the RAN node to implement the identified allocation.

10. The non-transitory computer-readable medium of claim 9, wherein the metrics comprise data in a buffer of the RAN node, age of the data in the buffer, traffic load, distance from a tower, or concentration of user devices in the area.

11. The non-transitory computer-readable medium of claim 9, wherein the identified allocation comprises a directionality and power of signals to be transmitted by the RAN node and wherein the one or more commands comprise configuring hardware settings or software settings of the at least one hardware component.

12. The non-transitory computer-readable medium of claim 9, wherein a first network standard and second network standard of the at least two network standards are different and include any combination of 1G (First Generation), 2G (Second Generation), 3G (Third Generation), 4G (Fourth Generation), 5G (Fifth Generation), or LTE (Long-Term Evolution).

13. The non-transitory computer-readable medium of claim 9, wherein the machine learning model is configured to identify clusters of user devices and the identified allocation comprises a directionality and power proportional to a number of user devices of each cluster.

14. The non-transitory computer-readable medium of claim 9, wherein the at least one hardware component comprises a radio amplifier having a maximum power output and the identified allocation comprises partitioning available wattage of the radio amplifier between a first network standard and a second network standard of the at least two network standards.

15. The non-transitory computer-readable medium of claim 9, wherein the instructions further cause operations including:
receiving a dataset comprising metrics indicative of (1) network demand for different combinations of network standards across user devices at one or more RAN nodes and (2) a corresponding distance of each user device to a corresponding RAN node; and
training the machine learning model to determine a distance of a user device from a RAN node based on metrics.

16. A system for dynamic hardware allocation for telecommunications networks, the system comprising:
one or more processors; and
one or more non-transitory, computer-readable media comprising instructions that, when executed by the one or more processors, causes operations comprising:
accessing one or more records indicative of network demand at a radio access network (RAN) node, wherein the RAN node is capable of supporting at least two network standards and comprises one or more hardware components for cell site infrastructure shared between the at least two network standards;
extracting, from the one or more records, metrics indicative of network demand for each network standard across a plurality of user devices in an area serviced by the RAN node;
inputting the metrics into a machine learning model to determine, for each user device of the plurality of user devices, a distance and directionality from the RAN node;
identifying, based on the distance of each user device from the RAN node, an allocation of hardware for each of the at least two network standards; and
generating one or more commands for enabling real-time modification of at least one hardware component of the one or more hardware components at the RAN node based on the identified allocation for each of the at least two network standards.

17. The system of claim 16, wherein the instructions further cause operations including transmitting the one or more commands, wherein the commands are configured to use software modifications to effectuate real-time modification of behavior of at least one hardware component at the RAN node to implement the identified allocation.

18. The system of claim 16, wherein the identified allocation comprises a directionality and power of signals to be transmitted by the RAN node and wherein the one or more commands comprise configuring hardware settings or software settings of the at least one hardware component.

19. The system of claim 16, wherein a first network standard and second network standard of the at least two network standards are different and include any combination of 1G (First Generation), 2G (Second Generation), 3G (Third Generation), 4G (Fourth Generation), 5G (Fifth Generation), or LTE (Long-Term Evolution).

20. The system of claim 16, wherein the machine learning model is configured to identify clusters of user devices and the identified allocation comprises a directionality and power proportional to a number of user devices of each cluster.
